(19) United States
(12) Patent Application Publication
(10) Pub. No.: US 2020/0384422 A1
(43) Pub. Date: Dec. 10, 2020

(54) Graphene or Graphene Derivative Membrane

(71) Applicant: G2O Water Technologies Limited, Manchester (GB)

(72) Inventor: Kangsheng Liu, Manchester (GB)

(73) Assignee: G2O Water Technologies Limited, Manchester (GB)

(21) Appl. No.: 16/767,374

(22) PCT Filed: Nov. 23, 2018
(86) PCT No.: PCT/GB2018/053383

§ 371 Date: May 27, 2020

(30) Foreign Application Priority Data
Nov. 28, 2017 (GB) 1719767.4

(51) Int. Cl. B01D 71/02; B01D 69/10; C01B 32/198; C02F 1/00

(52) U.S. Cl. CPC B01D 71/021; C02F 1/001; C01B 32/198; B01D 69/105

(57) ABSTRACT

A filtration membrane, suitably for water filtration, comprising a porous substrate layer and an active layer arranged over at least a part of the substrate layer. The active layer has a lamellar structure comprising at least two layers of two-dimensional material. The two-dimensional material comprises graphene or a derivative thereof. There is also provided a method for producing filtration membranes and filtration devices containing the filtration membranes.

### FIELD

The present invention relates to membranes. More specifically, the present invention relates to a method for printing filtration membranes, suitably for water treatment.

### BACKGROUND

Membrane filtration uses a layer of semi-permeable material to separate a mixture of components, generally with the application of a driving force applied across the surface of membrane, such as pressure.

Membrane filtration is favoured over other water treatment technologies due to, in principle, no significant thermal input, fewer chemical additives and a lower requirement for the regeneration of spent media. Pressure-driven membrane processes are the most widely applied membrane technologies in water treatment, for the removal of particulates, ions, microorganisms, bacteria and natural organic materials, covering different applications from waste water treatment from the food and oil industry to seawater desalination.

Typically, filtration membranes are categorised in accordance with the characteristic pore size or intended applications. Microfiltration membranes (MF), having pore sizes down to 100 nm, can be used to remove bacteria, suspending particles and some viruses. Ultrafiltration membranes (UF), having pore sizes down to 10 nm, can be used to remove proteins, viruses and colloidal particles. Nanofiltration membranes (NF), with pore sizes down to 1 nm, can be used to provide the ability of selecting multivalent ions and dissolved compounds. Reverse osmosis membranes (RO), with pore sizes down to 0.1 nm, only allow water to pass through.

Currently, the commercially available filtration membranes perform well in many applications; however, the drive to produce new water resources and protect existing water resources demands more advanced membranes having improved anti-fouling properties, selectivity, productivity, and longer life span at low cost and having more controllable manufacturing defects. New materials and new processing technologies having properties to fulfil the demands are desired.

Nanomaterials, or two-dimensional materials, may be of interest for use in the filtration membranes of commercial filter devices. However, such materials can present problems in relation to scalability, as well as the high cost of the materials and of the manufacturing processes.

In general, a robust filtration membrane for water treatment should display properties including high chemical, mechanical and thermal stability, good fouling resistance with cleanability, long life span, high permeability and controllable selectivity. Membranes should also have commercial accessibility, such as low material and manufacturing costs, high manufacturing scalability, and reasonable lead times to commercialisation.

Therefore, there is a requirement for improved membranes for filtration. It is therefore an object of aspects of the present invention to address one or more of the above mentioned or other problems.

### SUMMARY

According to a first aspect of the present invention, there is provided a filtration membrane, suitably for water filtration, comprising a porous substrate layer and an active layer arranged over at least a part of the substrate layer, wherein the active layer has a lamellar structure comprising at least two layers of two-dimensional material, and wherein the two-dimensional material comprises graphene or a derivative thereof.

According to a second aspect of the present invention there is provided a method of producing a filtration membrane, suitably a membrane according to the first aspect of the present invention, wherein the membrane comprises a porous substrate layer and an active layer arranged over at least a part of the substrate layer, wherein the active layer has a lamellar structure comprising at least two layers of two-dimensional material, and wherein the two-dimensional material comprises graphene or a derivative thereof, the method comprising the steps of:
a. optionally treating the substrate
b. contacting the substrate with a coating composition comprising the graphene or derivative thereof;
c. optionally, drying the membrane.

According to a third aspect of the present invention, there is provided a filtration membrane, suitably a membrane according to the first aspect of the present invention, wherein the membrane comprises a porous substrate layer and an active layer arranged over at least a part of the substrate layer, wherein the active layer has a lamellar structure comprising at least two layers of two-dimensional material, and wherein the two-dimensional material comprises graphene or a derivative thereof, wherein the membrane is produced by a method comprising the steps of:
a. optionally treating the substrate
b. contacting the substrate with a coating composition comprising the graphene or derivative thereof;
c. optionally, drying the membrane.

According to a further aspect of the present invention there is provided a method of producing a filtration membrane, suitably a membrane according to any other aspect of the present invention, wherein the membrane comprises a porous substrate layer and an active layer arranged over at least a part of the substrate layer, wherein the active layer has a lamellar structure comprising at least two layers of two-dimensional material, and wherein the two-dimensional material comprises graphene or a derivative thereof, the method comprising the steps of:
a. optionally treating the substrate
b. printing a coating composition comprising the graphene or derivative thereof onto the substrate;
c. optionally, drying the membrane.

According to a further aspect of the present invention, there is provided a filtration membrane, suitably a membrane according to the first aspect of the present invention, wherein the membrane comprises a porous substrate layer and an active layer arranged over at least a part of the substrate layer, wherein the active layer has a lamellar structure comprising at least two layers of two-dimensional material, and wherein the two-dimensional material comprises graphene or a derivative thereof, wherein the membrane is produced by a method comprising the steps of:
a. optionally treating the substrate
b. printing a coating composition comprising the graphene or derivative thereof onto the substrate;
c. optionally, drying the membrane.

According to a further aspect of the present invention there is provided a method of producing a filtration membrane, suitably a membrane according to the first aspect of the present invention, wherein the membrane comprises a porous substrate layer and an active layer arranged over at least a part of the substrate layer, wherein the active layer comprises graphene or derivative thereof, the method comprising the steps of:
a. optionally treating the substrate
b. inkjet printing a coating composition comprising the graphene or derivative thereof onto the substrate;
c. optionally, drying the membrane.

According to a further aspect of the present invention, there is provided a filtration membrane, suitably a membrane according to the first aspect of the present invention, wherein the membrane comprises a porous substrate layer and an active layer arranged over at least a part of the substrate layer, wherein the active layer comprises graphene or derivative thereof, wherein the membrane is produced by a method comprising the steps of:
a. optionally treating the substrate
b. inkjet printing a coating composition comprising the graphene or derivative thereof onto the substrate;
c. optionally, drying the membrane.

According to a further aspect of the present invention there is provided a coating composition for use in the manufacture of filtration membranes, suitably for use in the inkjet printing of filtration membranes, the composition comprising graphene or derivative thereof.

The substrate layer of any aspect of the present invention may comprise any porous material operable to support the active layer during the filtration process. The substrate may comprise one layer or multiple layers.

The substrate may be formed from material such as porous films, hollow fibres, and bulky shapes. Suitably the substrate is formed from a porous film.

The porous film may be selected from inorganic porous films, organic porous films and inorganic-organic porous films.

An inorganic porous film may be formed from materials selected from one or more of zeolite, silicon, silica, alumina, zirconia, mullite, bentonite and montmorillonite clay substrate.

An organic porous film may be formed from materials selected from one or more of polyacrylonitrile (PAN), polyamide (PA), Poly(ether) sulfone (PES), cellulose acetate (CA), poly(piperazine-amide), polyvinylidene fluoride (PVDF), polytetrafluoroethylene (PTFE), poly(phthalazinone ether sulfone ketone) (PPESK), polyamide-urea, poly (ether ether ketone), polypropylene, poly(phthalazinone ether ketone), and thin film composite porous films (TFC), suitably the TFC comprises an ultra-thin ‘barrier’ layer polymerised in situ over a porous polymeric support membrane, such as commercially available polyamide derived TFCs of an interfacially synthesized polyamide formed over a polysulphone membrane, and/or others TFCs such as poly(piperazine-amide)/poly(vinyl-alcohol) (PVA), poly(piperazine-amide)/poly(phthalazinone biphenyl ether sulfone (PPBES), hydrolyzed cellulose tri-acetate (CTA)/Cellulose acetate (CA) TFCs.

The porous film may be a nanotechnology-based porous film, such as nanostructured ceramic porous films, inorganic-organic porous films and/or non-woven nano porous fabric.

The nanostructured ceramic porous film may be formed of a layer of membranes, suitably conventional pressure driven membranes, with zeolite, suitably synthesized zeolite, on top of it such as via hydrothermal crystallisation or dry gel conversion methods. Other nanostructured ceramic porous films are reactive or catalyst coated ceramic surfaced substrates. Such substrates may advantageously lead to strong interaction with the active layer and improve the stability of the filters.

Inorganic-organic porous films containing mixed matrix membranes may be formed from inorganic particles contained in a porous organic polymeric film. An inorganic-organic porous film may be formed from materials selected from zirconia nanoparticles with polysulphone porous membrane. Advantageously, an inorganic-organic porous film may provide a combination of an easy to manufacture low cost substrate having good mechanical strength. An inorganic-organic porous film, such as zirconia nanoparticles with polysulphone may advantageously provide elevated permeability. Other inorganic-organic porous films may be selected from thin film nanocomposite membranes comprising one or more type of inorganic particle; metal based (aluminium foam, copper foam, Pb foam, zirconium foam and Sn foam, gold foam; mixed matrix substrates comprising inorganic fillers in an organic matrix to form organic-inorganic mixed matrix.

The porous substrate may comprise a non-woven nano fabric. Advantageously, a non-woven nano fabric provides high porosity, high surface area, and/or controllable functionalities. The non-woven fabric may comprise fibres with diameter at nanoscale. The non-woven fabric may be formed of cellulose acetate, polyethylene terephthalate (PET), polyolefins such as polyethylene and polypropylene, and/or polyurethane, suitably by electrospinning, suitably using cellulose acetate, polyurethane, etc.

The substrate may be manufactured as flat sheet stock or as hollow fibres and then made into one of the several types of membrane substrates, such as hollow-fibre substrate, or spiral-wound membrane substrate. Suitable flat sheet substrates may be obtained from Dow Filmtec and GE Osmonics.

Preferably, the substrate is a porous polymeric film. Advantageously, a substrate in the form of a porous polymeric film can provide improved ease in processing and/or lower cost.

The substrate may be selected from one or more of polyamide (PA), polysulphone (PSO, polyvinylidene fluoride (PVDF), and thin film composites (TFC), such as polysulphone supported polyamide composite film. Preferably, the substrate is selected from one or more of polyamide (PA), polysulphone (PSO, and thin film composite (TFC), such as polysulphone supported polyamide composite film.

The substrate may be a treated substrate. A surface of the substrate operable to receive the coating composition may have been subjected to hydrophilisation. Said substrate treatment may comprise the addition, suitably the grafting, of functional groups and/or the addition of hydrophilic additives. The added functional groups may be selected from one or more of hydroxyl, ketone, aldehyde, carboxylic acid and amine groups. The grafting of functional groups may be by plasma treatment, redox reaction, radiation, UV-ozone treatment, and/or chemical treatment. Hydrophilic additives may be selected from polyvinyl alcohol, polyethylene glycol, nanofillers, surface modifying macromolecules and zwitterions. The addition of additives may be carried out by coating or depositing additives with desired functionality on the membrane surface.

Advantageously, the presence of said hydrophilicity and/or functionality on the substrate provides an active layer having a more uniform structure and improved continuity. The said hydrophilicity and/or functionality may also provide improved filter life span and stability.

The substrate layer may have any suitable pore size. The support is typically a microporous membrane or an ultrafiltration membrane, preferable an ultrafiltration membrane. The pore size of the substrate layer may be from 0.1 nm to 4000 nm, such as 3000 nm, or 2000 nm, 1000 nm or 500 nm, such as 250 nm, 100 nm, 50 nm or film. Preferably, the pore size of the substrate is smaller than the average size of the particles of the two-dimensional material. For example, should the graphene oxide be in the form of flakes having average size of 500 nm, the pore size of the porous substrate is preferably smaller than 500 nm.

The substrate layer may have any suitable thickness. The thickness of the substrate layer may be between 5 to 125 μm, such as between 5 to 100 μm, or between 10 to 100 μm, or between 30 and 100 μm, preferably between 30 and 90 μmm more preferably between 30 and 85 μm, such as between 30 and 70 μm, or between 30 and 60 μm. Optionally, the substrate layer may have a thickness of between 5 and 30 μm, such as between 8 and 25 μm or between 8 and 20 μm, preferably between 10 and 15 μm, suitably said substrate is a polysulfone substrate.

The substrate may have a surface roughness, suitably Rz, such as from 0 to 1 μm, such as <500 nm or <300 nm, for example <200 nm or <100 nm, preferably <70 nm or <50 nm, more preferably <30 nm. Advantageously, low surface roughness can provide improved uniformity of the structure in the active layer.

The surface of the substrate operable to receive the active layer may be hydrophilic. Suitably, contact angle of the coating composition on the substrate surface is <90°, such as <70° and preferably <50°.

The active layer of any aspect of the present invention may have a thickness of from 2 to 1 μm, such as from 3 to 800 nm or from 4 to 600 nm, such as 5 to 400 nm or 5 to 200 nm, preferably 5 to 150 nm or 5 to 100 nm.

The graphene or derivative thereof may be selected from one or more of graphene oxide, reduced graphene oxide, hydrated graphene and amino-based graphene, alkylamine functionalised graphene oxide, ammonia functionalised graphene oxide, amine functionalised reduced graphene oxide, octadecylamine functionalised reduced graphene oxide, and/or polymer graphene aerogel. Preferably, the graphene or derivative thereof is graphene oxide. Graphene and its derivatives may be obtained commercially from Sigma-Aldrich.

Suitably, the graphene or derivative thereof, preferably graphene oxide, comprises hydroxyl, carboxylic and/or epoxide groups. The oxygen content of the graphene or derivative thereof, preferably graphene oxide, may be from 0 to 60% oxygen atomic percentage, such as 0 to 50% or 0 to 45% oxygen atomic percentage. Suitably, the oxygen content is from 20 to 25% or from 25 to 45%. Advantageously, when the water content is between 25 to 45% a surfactant may not be present in the composition. Preferably, the oxygen content is from 30-40% oxygen atomic percentage. Such a range can provide improved stability despite the absence of other stabilising components. Suitably, when the graphene or derivative is reduced graphene oxide, the oxygen content is from 5 to 20% oxygen atomic percentage. Oxygen content can be characterised by X-ray photoelectron spectroscopy (XPS).

The graphene or derivative thereof, suitably graphene oxide, may be optionally substituted with further functional groups. The optional functional groups may be grafted functional groups, and preferably grafted via reaction with the existing hydroxyl, carboxylic and epoxide groups of the graphene or derivative thereof. Functionalisation includes covalent modification and non-covalent modification. Covalent modification method can be subcategorised to nucleophilic substitution reaction, electrophilic substitution reaction, condensation reaction, and addition reaction. Examples of optional functional groups are amine groups; aliphatic amine groups, such as long-chain (e.g. C₁₅ to C₅₀) aliphatic amine groups; porphyrin-functionalised secondary amine groups, and/or 3-amino-propyltriethoxysilane groups. The graphene or derivative thereof may comprise amino groups, suitably grafted amino groups, and preferably to graphene oxide. Such functionalisation can provide for the improved selective sieving of ferric acid.

The graphene or derivative thereof according to any aspect of the present invention may be in the form of flakes having a size of from 1 nm to 5000 nm, such as between 50 to 750 nm, 100 to 500 nm, 100 to 400 nm. The graphene or derivative thereof according to any aspect of the present invention may be in the form of flakes having a size of from 100 to 3500 nm, such as from 200 to 3000 nm, 300 to 2500 nm or 400 to 2000 nm, preferably from 500 to 1500 nm. The graphene or derivative thereof according to any aspect of the present invention may be in the form of flakes having a size of from 500 to 4000 nm, 500 to 3500 nm, 500 to 3000 nm, 750 to 3000 nm, 1000 to 3000 nm, such as 1250 to 2750 nm or preferably 1500 to 2500 nm. Suitably, the size distribution of the graphene flakes or derivative thereof is such that at least 30 wt % of the graphene flakes or derivative thereof have a diameter of between 1 nm to 5000 nm, such as between 1 to 750 nm, 100 to 500 nm, 100 to 400 nm; or between 100 to 3500 nm, such as from 200 to 3000 nm, 300 to 2500 nm or 400 to 2000 nm, preferably from 500 to 1500 nm; or between 500 to 4000 nm, 500 to 3500 nm, 500 to 3000 nm, 750 to 3000 nm, 1000 to 3000 nm, such as 1250 to 2750 nm or preferably 1500 to 2500 nm, more preferably at least 40 wt %, 50 wt %, 60 wt %, 70 wt % and most preferably at least 80 wt % or at least 90 wt % or 95 wt % or 98 wt % or 99 wt %. The size of the graphene flakes or derivative thereof and size distribution may be measured using transmission electron microscopy (TEM, JEM-2100F, JEOL Ltd. Japan).

The graphene or derivative thereof may be in the form of a monolayer or multi-layered particle, preferably a monolayer. The graphene flakes or derivative thereof may be formed of single, two or few layers of graphene or derivative thereof, wherein few may be define as between 3 and 20 layers. Suitably, the graphene flakes or derivative thereof comprise between 1 to 15 layers, such as between 2 to 10 layers or 5 to 15 layers. Suitably, at least 30 wt % of the graphene flakes or derivative thereof comprise between 1 to 15 layers, such as between 1 to 10 layers or 5 to 15 layers, more preferably at least 40 wt %, 50 wt %, 60 wt %, 70 wt % and most preferably at least 80 wt % or at least 90 wt % or 95 wt % or 98 wt % or 99 wt %. The number of layers in the graphene flakes or derivative thereof may be measured using atomic force microscopy (AFM or transmission electron microscopy (TEM)) (TT-AFM, AFM workshop Co., CA, USA).

Suitably, the d-spacing between adjacent lattice planes in the graphene or derivative thereof is from 0.34 nm to 1000 nm, such as from 0.34 nm to 500 nm, or from 0.4 to 500 nm, or from 0.4 to 250 nm, such as from 0.4 to 200 nm, or from 0.4 to 150 nm, or from 0.4 to 100 nm, or from 0.4 to 50 nm, or from 0.4 to 25 nm, or from 0.4 to 10 nm, or from 0.4 to 5 nm, such as from 0.45 to 4 nm, from 0.5 to 3 nm, 0.55 to 2 nm, or 0.55 to 1.5 nm, or 0.6 to 1.2 nm, for example 0.6 to 1.1 nm, 0.6 to 1 nm, 0.6 to 0.9 nm, or 0.6 to 0.8 nm.

The active layer may comprise materials, suitably two-dimensional materials, other than graphene or derivatives thereof. For example, other materials of the active layer may be selected from one or more of silicene, germanene, stanene, boron-nitride, suitably h-boron nitride, carbon nitride, metal-organic nanosheets, molybdenum disulfide, and tungsten disulfide, polymer/graphene aerogel.

The materials of the active layer may be produced using any of the suitable methods known to the skilled person. Two-dimensional silicene, germanene and stanene may be produced by surface assisted epitaxial growth under ultrahigh vacuum. Hexagonal two-dimensional h-boron nitride may be produced by several methods, such as mechanical cleavage, unzipping of boron nitride nanotubes, chemical functionalisation and sonication, solid-state reaction and solvent exfoliation and sonication. Among these methods, chemical method has been found to provide the highest yield. For example h-boron nitride may be synthesised on single-crystal transition metal substrates using borazine as boron and nitride sources. Two-dimensional carbon nitride can be prepared via direct microwave heating of melamine and carbon fibre. Metal-organic frameworks (MOFs) can be produced by in-situ solvothermal synthesis method by mixing ingredients at high temperatures such as 100-140° C., followed by filtration. Two-dimensional molybdenum disulfide can be obtained by a few methods, such as mechanical exfoliation, liquid exfoliation and chemical exfoliation. Among these methods, chemical exfoliation has been found to provide high yield. One example is chemical exfoliation using lithium to chemically exfoliate molybdenum disulfide using centrifuge and filtration. Two-dimensional tungsten disulfide can be prepared by a deposition-thermal annealing method: vacuum deposition of tungsten and followed by thermal annealing by addition of sulphur. Polymer/graphene aerogel can be produced via coupling and subsequent freeze-drying using polyethylene glycol grafted graphene oxide.

Preferably, the active layer is substantially formed from two-dimensional material, suitably of graphene or a derivative thereof, more preferably graphene oxide or reduced graphene oxide, most preferably graphene oxide.

The membrane may comprise two or more discrete portions of active layers on the substrate.

The membrane of the present invention may be for any type of filtration. Suitably, the membrane of the present invention is for water treatment, such as oil/water separation; pharmaceutical filtration for removal of pharmaceutical residues in the aquatic environment; biofiltration, for example separation between micro-organisms and water; desalination or selective ion filtration; and nuclear waste water filtration for removal of nuclear radioactive elements from nuclear waste water; for blood treatment such as physiological filtration to replace damaged kidney filter and blood filtration; and/or separation of bioplatform molecules derived from sources such as plants, for example a grass. Suitably the membrane is for water treatment, such as desalination or oil and water separation, or for pharmaceutical filtration.

The method according to any aspect of the present invention may comprise printing the coating composition onto the substrate using inkjet printing, aerosol printing, 3D printing, offset lithography printing, gravure printing, flexographic printing techniques, pad printing, curtain coating, dip coating, spin coating and other printing or coating techniques known to those skilled in the art.

Preferably, the method according to the present invention comprises inkjet printing the coating composition onto the substrate.

Suitably, the substrate is treated prior to the addition of the coating composition. The addition of additives may be carried out by coating or depositing additives with desired functionality on the membrane surface.

Advantageously, surface treatment can provide improved uniformity of the active layer on the membrane. Surface treatment can also improve properties including the antifouling performance of the membrane, enhanced salt rejection and/or enchanced permeability. Fouling is a phenomenon of declining in flux and the life-span of a membrane due to different types of fouling, such as organic fouling, biofouling, and colloidal fouling.

Suitably the coating composition is a liquid composition comprising a liquid carrier and the graphene or derivative thereof. The coating compositions of the present invention may comprise solvent, non-solvent or solvent-less, and may be UV curable compositions, e-beam curable compositions etc. When formulated as a liquid composition for use in the invention, e.g. as a solution, dispersion or suspension, a suitable carrier liquid or solvent may be aqueous or organic, and other components will be chosen accordingly. For example, the liquid carrier may comprise water or an organic solvent such as isopropanol, methyl ethyl ketone, ethanol or ethyl acetate, optionally with other materials to enhance performance and/or rheology of the composition including any one or more of binders, drying additives, antioxidants, reducing agents, lubricating agents, plasticisers, waxes, chelating agents, surfactants, pigments, defoamers and sensitisers.

The liquid carrier, suitably for graphene oxide, may be selected from water, acetone, methanol, ethanol, propanol, iso-propanol, ethylene glycol, tetrahydrofuran (THF), propylene glycol, acetone, N,N-dimethylformamide (DMF), ethylene glycol, propylene glycol, tetrahydrofuran, ethyl acetate, toluene, xylene, or mixtures thereof. Preferably, the liquid carrier is selected from water, acetone, or water/acetone mixtures, such as 20-80 vol. % water/acetone mixtures. The liquid carrier, suitably for graphene and/or reduced graphene oxide, may be selected from water, acetone, methanol, ethanol, propanol, iso-propanol, ethylene glycol, tetrahydrofuran (THF), propylene glycol, acetone, N,N-dimethylformamide (DMF), N-methyl-2-pyrrolidone (NMP), ethylene glycol, propylene glycol, tetrahydrofuran, ethyl acetate, toluene, xylene, or mixtures thereof, preferably, water, optionally with one or more surfactants, or N-methyl-2-pyrrolidone (NMP), most preferably, water.

The concentration of the graphene or derivative thereof in the coating composition may be from 0.3 mg/ml to 4 mg/ml, such as from 0.3 mg/ml to 3 mg/mi or from 0.3 mg/ml to 2 mg/ml, or preferably from 0.3 to 1.5 mg/ml. When the concentration is too low, such as lower than 0.3 mg/ml, leakage of the ink from the cartridge could occur, and when the concentration is too high, such as higher than 4 mg/ml, three-dimensional colloid could form resulting in high viscosity which is not suitable for printing.

The size of the graphene flakes or derivative thereof may be ≤ 1/10 of the nozzle size, such as ≤ 1/15 of the nozzle size. For example, for nozzle having diameter of 20 um, the flake may have a size of ≤2 um. Such a ratio of flake size to nozzle size can advantageously provide reduced nozzle clogging.

Optionally, the composition may comprise a surfactant and/or organic solvent, suitably when the oxygen content is <25%. The surfactant may be selected from one or more of polyethylene glycol (PEG), isopropanol, propylene glycol, ethylene glycol, sodium dodecylbenzenesulphonate, cyclohexanone, terpineol,4-(1,1,3,3-Tetramethylbutyl)phenyl-polyethylene glycol,t-Octylphenoxypolyethoxyethanol, Polyethylene glycol tert-octylphenyl ether and ethanol. The organic solvent may be N-methyl-2-pyrrolidone (NMP).

The coating composition of the present invention may comprise a binder. Suitable binders for use in the composition may be one or more selected from resins chosen from acrylics, acrylates, alkyds, styrenics, cellulose, cellulose derivatives, polysaccharides, polysaccharide derivatives, rubber resins, ketones, maleics, formaldehydes, phenolics, epoxides, fumarics, hydrocarbons, urethanes, polyvinyl butyral, polyamides, shellac, polyvinyl alcohol or any other binders known to those skilled in the art. It has been found that the addition of a binder can advantageously improve the mechanical strength of the membrane and extend the life span.

The viscosity of the coating composition may be from 1 to 14 cPa, preferably 5 to 15 cPa, such as 10 to12 cPa.

The surface tension of the coating composition may be from 1 to 150 mN/m, such as from 28 to 80 mN/m.

The composition may have a Z number of between 1 and 16. Said Z number is calculated according to the formula Z=√γρα/μ., in which μ is the viscosity of the coating composition (mPas), γ is the surface tension of the coating composition (mJ/m2), ρ is the density of the coating composition (g/cm-3), and a is the nozzle diameter of the inkjet printer head (μm).

Advantageously, the coating compositions of the present invention can provide high stability for a prolonged period. Furthermore, a concentration of <0.5 mg/ml has been found to give good droplet uniformity and stable jetting.

The coating composition of the present invention may be prepared by dispersing or dissolving one or more components in the liquid using any of: mechanical mixing, e.g. leading edge-trailing blade stirring; ceramic ball grinding and milling; silverson mixing; glass bead mechanical milling, e.g. in an Eiger Torrance motormill; Ultra Turrax homogeniser; mortar and pestle grinding; mechanical roll milling.

The inkjet printing may be drop on demand (DOD) inkjet printing, for example piezoelectric or thermal; or continuous inkjet printing (CIJ), preferably the inkjet printing is DOD inkjet printing.

The nozzle size of the inkjet printer may be from 5 μm to 100 μm, preferably from 5 μm to 60 μm.

The cartridge drop volume may be from 1 pl to 100 pl, suitably from 5 to 50 pl, or from 8 to 30 pl, such as 10 pl. The voltage and firing frequency of the inkjet printing method may depend on the waveform of the coating composition. The firing voltage may be from 10 to 30 V. The firing frequency may be from 3 kHz to 15 kHz, suitably about 5 KHz. The cartridge temperature of the inkjet printer may be from 20° C. to 50° C., suitably about 40° C. The stage temperature of the inkjet printer may be from 20° C. to 60° C., suitably about 21° C.

A raster with stochastic filters may be used during the printing processes. Advantageously, the use of said raster reduces overlapping of the graphene or derivative thereof and can provide improved homogeneous printing.

A sheet of clean room paper may be placed on the platen to reduce vacuum localisation.

The thickness of the active layer deposited by each pass of the inkjet printer may be at least 3 nm, such as at least 4 nm or at least 5 nm. The inkjet printing may apply the active layer with multiple passes.

Advantageously, the method of the present invention provides a time efficient method for producing active layers on a substrate that are of a controllable thickness, and allows for low thicknesses to be achieved. The method of the present invention advantageously produces improved uniformity in the active layer. The method of the present invention is scalable to allow for improved production of large numbers of membranes.

For application by other printing methods as detailed earlier, optimum parameters will be known to those skilled in the art. For example, for application by Flexography or gravure, the liquid composition should have a viscosity in the range of 15-35s Din #4 flow cup and a drying rate tailored to suit the substrate and print speed.

The filtration membranes according to the aspects of the present invention may be utilised in a wide range of architectures and filtration devices, including but not limited to those working under gravity filtration, vacuum filtration and/or pressurised systems.

The term lamellar structure herein means a structure having at least two overlapping layers. The term active layer herein means a layer operable to provide filtration across the layer. The term two-dimensional material herein means a material with at least one dimension of less than 100 nm.

The term aliphatic herein means a hydrocarbon moiety that may be straight chain, branched or cyclic, and may be completely saturated, or contain one or more units of unsaturation, but which is not aromatic. The term “unsaturated” means a moiety that has one or more double and/or triple bonds. The term “aliphatic” is therefore intended to encompass alkyl, alicyclic, alkenyl or alkynyl groups. An aliphatic group preferably contains 1 to 15 carbon atoms, such as 1 to 14 carbon atoms, 1 to 13 carbon atoms, that is, an aliphatic group with 1, 2, 3, 4, 5, 6, 7, 8, 9, 10, 11, 12, 13 carbon atoms.

An alkyl group contains 1 to 15 carbon atoms. Alkyl groups may be straight or branched chained. The alkyl group preferably contains 1 to 14 carbon atoms, 1 to 13 carbon atoms, that is, an alkyl group with 1, 2, 3, 4, 5, 6, 7, 8, 9, 10, 11, 12, 13 carbon atoms. Specifically, examples of an alkyl group include methyl, ethyl, n-propyl, iso-propyl, n-butyl, iso-butyl, sec-butyl, tert-butyl, n-pentyl, n-hexyl, n-heptyl, n-octyl, n-nonyl, n-decyl, n-undecyl, n-dodecyl, n-tridecyl, n-tetradecyl, n-pentadecyl, 1,1-dimethylpropyl, 1,2-dimethylpropyl, 2,2-dimethylpropyl, 1-ethylpropyl, n-hexyl, 1-ethyl-2-methylpropyl, 1,1,2-trimethylpropyl, 1-ethylbutyl, 1-methylbutyl, 2-methylbutyl, 1,1-dimethylbutyl, 1,2-dimethylbutyl, 2,2-dimethylbutyl, 1,3-dimethylbutyl, 2,3-dimethylbutyl, 2-ethylbutyl, 2-methylpentyl, 3-methylpentyl and the like, and isomers thereof.

Alkenyl and alkynyl groups each contain 2 to 12 carbon atoms, such as 2 to 11 carbon atoms, 2 to 10 carbons atoms, such as 2 to 9, 2 to 8 or 2 to 7 carbon atoms. Such groups may also contain more than one carbon-carbon unsaturated bond.

Alicyclic groups may be saturated or partially unsaturated cyclic aliphatic monocyclic or polycyclic (including fused, bridging and spiro-fused) groups which have from 3 to 15 carbon atoms, such as 3 to 14 carbon atoms or 3 to 13 carbon atoms, that is an alicyclic group with 3, 4, 5, 6, 7, 8, 9, 10, 11, 12, 13 carbon atoms. Preferably, an alicyclic group has from 3 to 12, more preferably from 3 to 11, even more preferably from 3 to 10, even more preferably from 3 to 9 carbon atoms, or from 3 to 8 carbons atoms or from 3 to 7 or 3 to 6 carbon atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substituents, such as —CH₂-cyclohexyl. Specifically, examples of C₃₋₁₅ cycloalkyl groups include cyclopropyl, cyclobutyl, cyclopentyl, cyclohexyl, cycloheptyl, adamantyl, isobornyl and cyclooctyl.

An aryl group is a monocyclic or polycyclic group having from 6 to 14 carbon atoms, such as 6 to 13 carbon atoms, 6 to 12, or 6 to 11 carbon atoms. An aryl group is preferably a “C₆₋₁₂ aryl group” and is an aryl group constituted by 6, 7, 8, 9, or 10 carbon atoms and includes condensed ring groups such as monocyclic ring group, or bicyclic ring group and the like. Specifically, examples of “C₆₋₁₀ aryl group” include phenyl, biphenyl, indenyl, naphthyl or azulenyl and the like. It should be noted that condensed rings such as indan and tetrahydro naphthalene are also included in the aryl group.

The use of the term “hetero” in heteroaliphatic and heteroaryl is well known in the art. Heteroaliphatic and heteroaryl refers to an aliphatic or aryl group, as defined herein, wherein one or more carbon atoms has been replaced by a heteroatom in the chain and/or ring of the group, as applicable, respectively. The heteroatom(s) may be one or more of sulphur and/or oxygen.

The heteroatom(s) may be in any form that does not remove the ability of the amine groups of the multifunctional amine to react with the multifunctional amine-reactive. The heteroatom(s) may be in the form of an ether group, such as C₁-C₁₅ alkoxy; if terminal, a hydroxyl group; sulphur and oxygen heterocycles; and/or a polysulphide group, such as a polysulphide containing at least two sulphur atoms.

Preferably, the alkoxy group contains from 1 to 8 carbon atoms, and is suitably selected from methoxy, ethoxy, propoxy, butoxy, pentlyoxy, hexyloxy, heptyloxy, octyloxy, and isomeric forms thereof.

All of the features contained herein may be combined with any of the above aspects in any combination.

For a better understanding of the invention, and to show how embodiments of the same may be carried into effect, reference will now be made, by way of example, to the following experimental data and figures.

### EXAMPLES

### Example 1—Preparation of Graphene Oxide-Containing Filtration Membrane

A dispersion of graphene oxide was prepared by dispersing 15 g of graphene oxide flakes into 50 L of water using industrial scale sonication, such as using ultrasonic homogeniser sonicator. The resultant dispersion had concentration of 0.3 mg/ml and viscosity of 10.7 cPa. The obtained dispersion was then applied to surface treated polysulfone using a Pixdro LP50 equipped with Xaar 1002 head assembly. Following drying under ambient conditions, the performance of the resultant membrane was then assessed and found to exhibit improvement of water flux by 20% compared to an uncoated membrane.

### Example 2—Preparation of a Reduced Graphene Oxide Membrane

A dispersion of reduced graphene oxide was prepared by dispersing 15 g of reduced graphene oxide and Triton X-100 non-ionic surfactant in 50 L water via industrial scale sonication, such as using ultrasonic homogeniser sonicator. The resultant dispersion had a concentration of 0.3 mg/ml and viscosity of 12 cPa. The obtained dispersion was then applied to surface treated polysulfone using a Pixdro LP50 equipped with Xaar 1002 head assembly. Following drying under ambient conditions, the performance of the resultant membrane was then assessed and found to exhibit improvement of selective sieving of organic molecules in comparison to an uncoated membrane.

### Example 3—Preparation of an Amino-Group Functionalised Graphene Oxide Membrane

A dispersion of amino-group functionalised graphene oxide was prepared by dispersing 15 g of amino-group functionalised graphene oxide in 50 L water via industrial scale sonication, such as using ultrasonic homogeniser sonicator. The resultant dispersion had a concentration of 0.3 mg/ml and viscosity of 10 cPa. The obtained dispersion was then applied to surface treated polyamide using a Pixdro LP50 equipped with Xaar 1002 head assembly. Following drying under ambient conditions, the performance of the resultant membrane was then assessed and found to exhibit improvement of removal of ferric acid from water in comparison to no removal from an uncoated membrane.

### Example 4—Preparation of a Filtration Membrane by Flexography

A dispersion of graphene oxide was prepared by the method detailed in example 1. 975 g of the dispersion was added to 25 g of BASF Joncryl LMV 7050 polymer emulsion and mixed thoroughly using a silverson homogeniser. The viscosity of the liquid coating was then adjusted to the desired print viscosity by addition of water. The liquid coating composition was then applied to a surface treated polysulfone substrate using a RK Printing proofer fitted with a flexo head. Following drying under ambient conditions, the performance of the resultant membrane was assessed and found to exhibit an improvement of 30% of water flux rate versus an uncoated membrane.

### Example 5—Preparation of a Filtration Membrane by Gravure Printing

A dispersion of graphene oxide was prepared by the method detailed in example 1. 975 g of the dispersion was added to 25 g of BASF Joncryl LMV 7050 polymer emulsion and mixed thoroughly using a silverson homogeniser. The liquid coating composition was then applied to a surface treated polysulfone substrate using a RK K printing proofer. Following drying under ambient conditions, the performance of the resultant membrane was assessed and found to exhibit an improvement of 25% of water flux rate versus an uncoated membrane.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-53. (canceled)

54. A filtration membrane for water filtration, comprising a porous substrate layer and an active layer arranged over at least a part of the substrate layer, wherein the active layer has a lamellar structure comprising at least two layers of two-dimensional material, and wherein the two-dimensional material is selected from the group consisting of graphene and a derivative thereof, and wherein the substrate is selected from the group consisting of a porous film substrate or a hollow fibre substrate.

55. A filtration membrane according to claim 54, wherein the membrane comprises a porous substrate layer and an active layer arranged over at least a part of the substrate layer, wherein the active layer has a lamellar structure comprising at least two layers of two-dimensional material, and wherein the two-dimensional material is selected from the group consisting of graphene and a derivative thereof; and further wherein the membrane is produced by a method comprising the steps of:
a. selecting substrate from a group consisting of a porous film substrate and a hollow fibre substrate;
b. optionally, treating the substrate; and
c. contacting the substrate with a coating composition comprising the selected graphene or derivative thereof.

56. A membrane according to claim 55, wherein the substrate is formed from a porous film selected from a group consisting of inorganic porous films, organic porous films and inorganic-organic porous films.

57. A membrane according to claim 56, wherein the porous film is formed from materials selected from the group consisting of zeolite, silicon, silica, alumina, zirconia, mullite, bentonite and montmorillonite clay substrate.

58. A membrane according to claim 56, wherein the porous film is formed from materials selected from the group consisting of polyacrylonitrile (PAN), polyamide (PA), Poly(ether) sulfone (PES), cellulose acetate (CA), poly(piperazine-amide), polyvinylidene fluoride (PVDF), polytetrafluoroethylene (PTFE), poly(phthalazinone ether sulfone ketone) (PPESK), polyamide-urea, poly (ether ether ketone), polypropylene, poly(phthalazinone ether ketone), and thin film composite porous films (TFC).

59. A membrane according to claim 54, wherein the substrate is formed from materials selected from the group consisting of polyamide (PA), polysulphone (PSf), polyvinylidene fluoride (PVDF) and thin film composites (TFC) including polysulphone supported polyamide composite film.

60. A membrane according to claim 54, wherein the substrate is a treated substrate, the surface of the substrate being operable to receive a coating composition has been subjected to hydrophilisation and the addition of at least one functional group selected from the group consisting of hydrophilic additives consisting of hydroxyl, ketone, aldehyde, carboxylic acid and amine groups, and wherein the hydrophilic additives are selected from a group consisting of polyvinyl alcohol, polyethylene glycol, nanofillers, surface modifying macromolecules and zwitterions.

61. A membrane according to claim 54, wherein the substrate has an Rz surface roughness of from 0 to 1 μm.

62. A membrane according to claim 54, wherein the substrate has an Rz surface roughness selected from the group of roughness values consisting of <500 nm, <300 nm, <200 nm and <100 nm, <30 nm, <50 nm and <70 nm.

63. A membrane according to claim 54, wherein at least one surface of the substrate is operable to receive the active layer, and further wherein the active layer is hydrophilic.

64. A membrane according to claim 54, wherein the active layer has a thickness of from 2 to 1 μm.

65. A membrane according to claim 54, wherein the active layer has a thickness of from 3 to 800 nm or from 4 to 600 nm, such as 5 to 400 nm or 5 to 200 nm, preferably 5 to 150 nm or 5 to 100 nm.

66. A membrane according to claim 54, wherein the graphene or a derivative thereof is selected from the group consisting of graphene oxide, reduced graphene oxide, hydrated graphene, amino-based graphene, alkylamine functionalised graphene oxide, ammonia functionalised graphene oxide, amine functionalised reduced graphene oxide, octadecylamine functionalised reduced graphene oxide and polymer graphene aerogel.

67. A membrane according to claim 66, wherein the selected graphene or derivative thereof is selected from the group consisting of graphene oxide, reduced graphene oxide and amino-group functionalised graphene oxide.

68. A membrane according to claim 66, wherein the selected graphene or derivative is reduced graphene oxide with an oxygen content of from 5 to 20% oxygen atomic percentage.

69. A membrane according to claim 66, wherein the selected graphene or graphene derivative comprises amino groups.

70. A membrane according to claim 69, wherein the selected graphene or graphene derivative comprises grafted amino groups.

71. A membrane according to claim 54, wherein the selected graphene or the graphene derivative is in flake form, wherein the size distribution of the selected graphene flakes or graphene derivative thereof is such that at least 30 wt % of the flakes have a diameter selected from the range of diameters selected from the group consisting of from 1 to 750 nm, from 100 to 500 nm, from 100 to 400 nm, from 100 to 3500 nm, from 200 to 3000 nm, from 300 to 2500 nm, from 400 to 2000 nm, from 500 to 1500 nm, from 500 to 4000 nm, from 500 to 3500 nm, from 500 to 3000 nm, from 750 to 3000 nm, from 1000 to 3000 nm, from 1250 to 2750 nm and from 1500 to 2500 nm.

72. A membrane according to claim 71, wherein the size distribution of the graphene flakes or derivative thereof is selected from the group consisting of size distributions of at least 40 wt %, 50 wt %, 60 wt %, 70 wt %, 80 wt %, 90 wt %, 95 wt %, 98 wt % and 99 wt %.

73. A membrane according to claim 54, wherein the membrane is adapted for a use selected from the use group consisting of water treatment, desalination, oil and water separation, and pharmaceutical filtration.

74. A membrane according to claim 54, wherein the graphene or derivative thereof is formed from a coating composition applied to the substrate, wherein the concentration of graphene or derivative thereof in the coating composition is selected from the group of compositions consisting of from 0.3 mg/ml to 4 mg/ml, from 0.3 mg/ml to 3 mg/ml, from 0.3 mg/ml to 2 mg/ml and from 0.3 to 1.5 mg/ml.

75. A membrane according to claim 74, wherein the viscosity of the coating composition is selected from the group of coating compositions consisting of 1 to 14 cPa, 5 to 15 cPa and 10 to12 cPa.

76. A membrane according to claim 74, wherein the surface tension of the coating composition is selected from the group of surface tensions consisting of from 1 to 150 mN/m and from 28 to 80 mN/m.

77. A membrane according to claim 74, wherein the coating composition has a Z number of between 1 and 16.

78. A method of producing a filtration membrane wherein the membrane comprises a porous substrate layer and an active layer arranged over at least a part of the substrate layer, wherein the active layer has a lamellar structure comprising at least two layers of two-dimensional material, and wherein the two-dimensional material comprises a material selected from the group of materials consisting of graphene and a derivative thereof, the method comprising the steps of:
a. selecting a substrate from a group of substrates consisting of a porous film substrate and a hollow fibre substrate;
b. optionally, treating the substrate to render it suitable for being coated; and
c. contacting the substrate with a coating composition comprising the selected graphene or graphene derivative.

79. A method according to claim 78, and including the step of drying the membrane subsequent to contacting the substrate with the coating composition.

80. A method according to claim 78, and including the step of inkjet printing the coating composition onto the substrate.
